(19) United States
(12) Patent Application Publication
(10) Pub. No.: US 2004/0092374 A1
(43) Pub. Date: May 13, 2004

(54) Processing structure for plastic film folding

(76) Inventor: Chiu-Fu Cheng, Hsin-Tien City (TW)

Correspondence Address: Chiu-Fu Cheng, P. O. Box No. 6-57, Chung-Ho, Taipei, 235, TW

(21) Appl. No.: 10/290,182

(22) Filed: Nov. 8, 2002

(51) Int. Cl. B31B 1/25

(52) U.S. Cl. 493/160

(57) ABSTRACT

A processing structure for plastic film folding is designed to fold and mold a sheet of plastic film with a thickness less than one percent of 1 mm through utilizing a rolling method to dispose an expanded drawing of a crease pattern on a rolling wheel; wherein, two ends of the rolling wheel are disposed with a guide wheel and a convey wheel for transmission; a rolling knife and a scoring knife are disposed at the center of the rolling wheels; the steadiness and rapidness of rolling for processing and molding the folding line as well as cutting reduce the defective fraction of a traditional punch processing.

### BACKGROUND OF THE INVENTION

1) Field of the Invention

The present invention relates to a processing structure for plastic film folding; it is mainly applied to a sheet of thinner plastic film by virtue of the steadiness and rapidness of a rolling method as well as a design having a rolling knife and a scoring knife with different wheel bases disposed on a rolling wheel so as to enhance the efficiency of promoting the folding job, mold processing and reducing the defective fraction of loss.

2) Description of the Prior Art

Accordingly, a traditional folding technique utilizes either a mechanical processing or a manual processing to accomplish a folding job; wherein, the mechanical processing is preferred by modern industry which emphasizes efficiency. A conventional processing machine for folding uses a punch press disposed with a molding tool; wherein, cutting edges of different depths are disposed on a folding line position at an end portion of the molding tool so as to exert a punching force to punch, press and mold the desired shape.

However, being one of the important technique in the traditional processing methods, the punching technique is not suitable for certain material because the punching force generated by a punching machine for molding might leave an extensive allowance which usually causes defective fraction of loss for some thinner or fragile material. Since the punch processing uses an idler and the gravity to make the punch to punch and contact a cutting mold and cutting board, it is necessary to control the punching force or the interval distance between the cutting mold and the cutting board. However, the conditions required for the abovementioned processing is very hard to control and the error of processing allowance is considerable big. Therefore, it seriously increases the processing cost and fraction of defection. Furthermore, the processing speed of punching thereof is limited to intermittent punching and material feeding such that the efficiency is limited also.

Therefore, the rolling and pressing technique is the processing for compensating the thinner material since its steadiness and rapidness can finish the processing when it feeds the material to pass the rolling wheel at the first instant; furthermore, the rotation of a motor controls its processing speed. In other words, it is merely necessary to adjust the transmission speed of the motor for accelerating the mold processing so as to obtain times of efficiency. In addition, there is no allowance problem existing in the transmission of the rolling wheel; with its steadiness, it is most suitable for processing the thinner and fragile material including sheets of plastic film or plastic film paper.

In viewing the limitation of the abovementioned application conditions, the inventor of the present invention disposed a rolling knife, a scoring knife and a guide wheel at the slit between the rolling wheels; wherein the guide wheel is respectively disposed at two ends of one of the rolling wheels to transmit with the other rolling wheel; the rolling knife and the scoring knife are disposed between the rolling wheel with an expanded pattern thereon; the steadiness and rapidness of the rolling are implemented in the processing of folding lines.

### SUMMARY OF THE INVENTION

The primary objective of the present invention is to provide a processing structure for plastic film folding, more particularly for a sheet of plastic film with a thickness less than one percent of 1 mm through utilizing a rolling method to dispose an expanded drawing of a crease pattern on a rolling wheel and utilizing the steadiness and rapidness of the rolling to implement in the mold processing of folding.

To enable a further understanding of achieving the technical contents of the present invention is described by the brief description of the drawings and the detailed description of a preferred embodiment.

### BRIEF DESCRIPTION OF THE DRAWINGS

FIG. 1 is a schematic drawing of conventional punch processing.

FIG. 2 is a pictorial drawing of an embodiment of the present invention.

FIG. 3 is a schematic and lateral view drawing of a rolling wheel of the present invention.

FIG. 4-1 is a schematic and cross-sectional drawing of an application status of the present invention.

FIG. 4-2 is a schematic and lateral view drawing of the application status of the present invention.

FIG. 5 is an expanded and schematic drawing of an object processed by the present invention.

FIG. 6 is a schematic drawing of the fold and mold processing of the present invention.

FIG. 7-1 is the first schematic drawing of another application of the present invention.

FIG. 7-2 is the second schematic drawing of another application of the present invention.

### DETAILED DESCRIPTION OF THE PREFERRED EMBODIMENTS

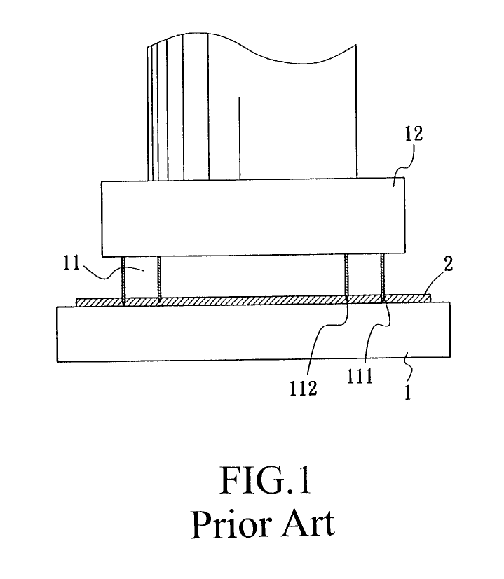

As indicated in FIG. 1, a punch process uses an idler and the gravity to make a punch (12) punch a cutting mold (11) downwardly such that a end side knife (111) contacts a cutting board (1) to cut a sheet of film paper (2); at the same time, a scoring knife (112) of the cutting mold (11) punches and molds the position to be folded. Since the punching force generated by a punching machine for molding might leave an extensive allowance which usually causes defective fraction of loss for some thinner or fragile material, it is necessary to control the punching force of the punch (12) or the interval distance between the cutting mold (11) and the cutting board (1). However, it is very hard to control the processing and the error of processing allowance is considerable big. Therefore, it seriously increases the processing cost and fraction of defection. Furthermore, the processing speed of punching is limited to intermittent punching and material feeding such that the efficiency is limited also.

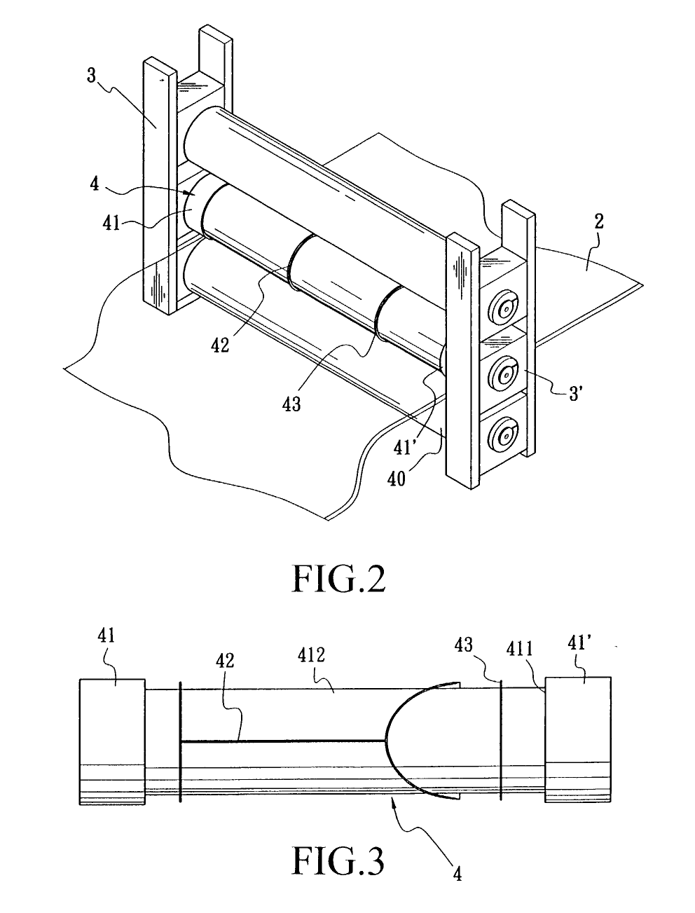

Referring to FIGS. 2 and 3, in viewing the shortcomings of using the abovementioned punch technique for processing a sheet of thinner film paper (2), the present invention of a processing structure for plastic film folding utilizes the rolling technique to compensate the processing for thinner material. As indicated in FIGS. 2 and 3, a regular rolling wheel of a processing machine comprises two corresponding seat frames (3, 3′); an upper rolling wheel (4) and a lower rolling wheel (40) are disposed between the corresponding seat frames (3, 3′); a sheet of film paper (2) inserts inbetween; a rolling knife (43), a scoring knife (42) and two guide wheels (41, 41′) are disposed on the upper rolling wheel (4); wherein the scoring knife (42) and the rolling knife (43) make the cross sections and folding lines disposed respectively on the periphery of the upper rolling wheel (4); the guide wheels (41, 41′) are disposed respectively at two ends of the upper rolling wheel (4); wherein the guide wheels (41, 41′) maintain the slit between the upper rolling wheel (4) and the lower rolling wheel (40) thereby increasing its steadiness.

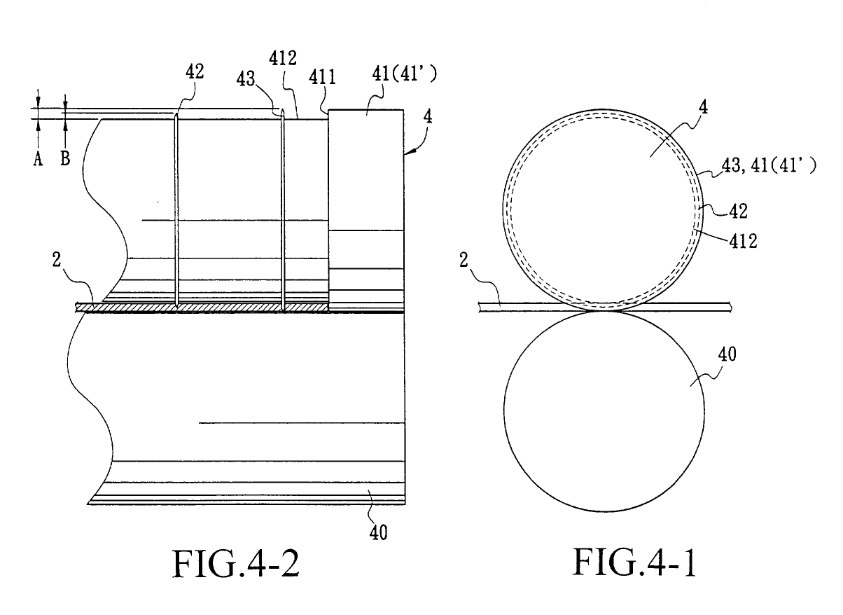

As indicated in FIGS. 4-1 and 4-2, the tight contact of the guide wheels (41, 41′) makes an inner rim (412) maintain a proper slit between the upper rolling wheel (4) and the lower rolling wheel (40) to allow the sheet of film paper (2) to insert inbetween. A guide sides (411) of the guide wheels (41, 41′) lead a parallel feeding of the sheet of film paper (2) such that the rolling knife (43) and the scoring knife (42) precisely cut the sheet of film paper (2) thereby decreasing the defective fraction. An end rim of an annular portion between the rolling knife (43) and the inner rim (412) maintains a distance (A) and that is the thickness of the sheet of film paper (2). The scoring knife (42) maintains a distance (B) with the inner rim (412) according to the required depth of the crease; wherein, the distance (B) of the scoring knife (42) should not be longer than the distance (A) of the rolling knife (43) because mainly the rolling knife (43) cuts the sheet of film paper (2) off while the scoring knife (42) only scores a crease on the sheet of film paper (2).

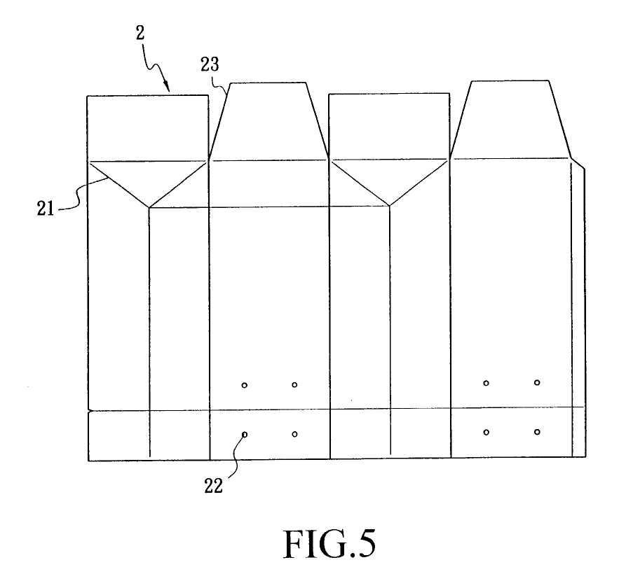

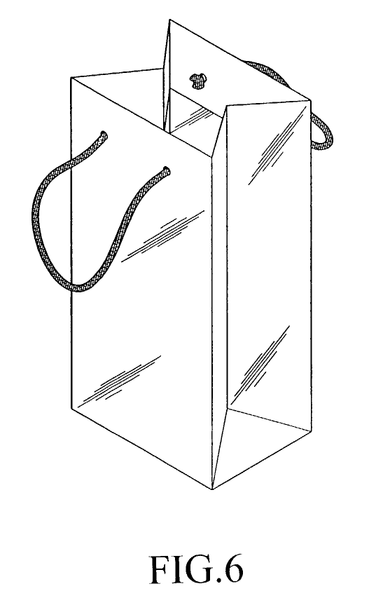

As indicated in FIGS. 5 and 6, after the sheet of film paper (2) is rolled, cut and molded into an expanded pattern for folding, a cut side (23), a folding line (21) and a through hole (22) are formed thereon; then, a bag is manufactured through folding and heating (ultra sonic) adhesion.

The present invention of the processing structure for folding a sheet of thinner film utilizes the rolling technique to compensate the processing of thinner material, such as the plastic film, plastic paper and cellophane paper, etc. Only the rolling method, not the traditional punch technique, is capable of precisely controlling the depth of cutting; the roll processing is stable and rapid; it feeds the material at the first instant to pass the rolling wheel and finish the processing; its processing is several times of efficiency than that of the punch processing. Furthermore, in the transmission of the rolling wheels, there is no allowance problem due to the punch vibration. Therefore, the precision of cutting and folding is not questionable.

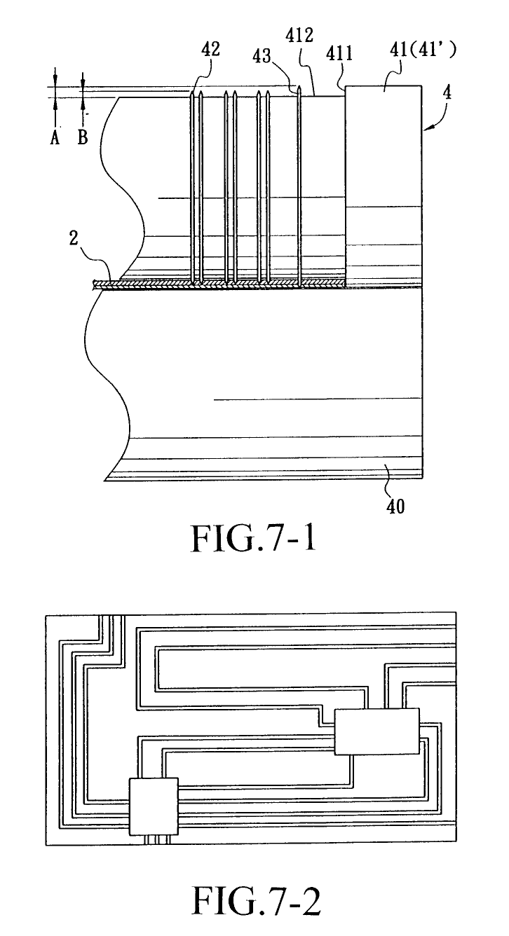

Referring to FIGS. 7-1 and 7-2, the present invention is applied in another embodiment. As indicated, the scoring knifes (42) are distributed on the upper rolling wheel (4) according to the expanded status of an integrated film printing circuit; the rolling knifes (43) are disposed at the cutting sides. When in operation, the scoring knifes (42) cut to make breaks according to the design of the circuit distribution; after molding, the rolling knife (43) finishes the cutting on the sides. Therefore, the precision and steadiness of the rolling wheel tremendously improve the traditional processing method; furthermore, the difference at the end portion between the rolling knife (43) and the scoring knife (42) is used for the function of cutting or heating adhesion thereby increasing the application scope of the rolling wheel design.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A processing structure for plastic film folding aiming to fold and mold a sheet of paper with a thickness less than one percent of 1 mm utilizes a rolling method of two corresponding convey rolling wheels to accomplish a processing procedure; wherein one rolling wheel is disposed with two guide wheels, a rolling knife and scoring knife; the present invention is characterized that:
two guide wheels are respectively disposed at two ends of one of the rolling wheels to allow a inner rim and the other rolling wheel to maintain a slit for a sheet of plastic film and an end distance between the rolling wheels as well as between the rolling knife and the scoring knife;
the rolling knife extends outwardly from the periphery of the inner rim of the rolling wheel; the extended thickness must be the thickness of the sheet of plastic film for cutting off;
the scoring knife extends outwardly from the periphery of the inner rim of the rolling wheel; the extended thickness must be less than the thickness of the sheet of plastic film for scoring a folding line;
the steadiness and rapidness of the rolling between the rolling wheels for scoring a folding line and cutting decrease the defective fraction of a traditional processing method.

2. The processing structure for plastic film folding according to claim 1, wherein the extension of the rolling knife from the inner rim of the rolling wheel must exceed the extension of the scoring knife.

3. The processing structure for plastic film folding according to claim 1, wherein the extension of the scoring knife from the inner rim of the rolling wheel must be between the inner rim of the rolling wheel and the rolling knife and able to contact the sheet of plastic film.

4. The processing structure for plastic film folding according to claim 1, wherein the extension of the scoring knife from the inner rim of the rolling wheel must be limited within the thickness of the sheet of plastic film.
